(19) United States
(12) Patent Application Publication
(10) Pub. No.: US 2019/0102025 A1
(43) Pub. Date: Apr. 4, 2019

(54) DISPLAY DEVICE

(71) Applicant: Sharp Kabushiki Kaisha, Sakai City (JP)

(72) Inventors: Hideki KITAGAWA, Sakai City (JP); Tohru DAITOH, Sakai City (JP); Hajime IMAI, Sakai City (JP); Yoshihito HARA, Sakai City (JP); Masaki MAEDA, Sakai City (JP); Toshikatsu ITOH, Sakai City (JP); Tatsuya KAWASAKI, Sakai City (JP)

(21) Appl. No.: 16/145,426

(22) Filed: Sep. 28, 2018

(30) Foreign Application Priority Data
Oct. 3, 2017 (JP) 2017-193310

(51) Int. Cl. G06F 3/041; G06F 3/044; G09G 3/36

(52) U.S. Cl. CPC G06F 3/0412; G06F 3/044; G09G 2354/00; G09G 3/3648; G06F 3/0416

(57) ABSTRACT

A display panel includes a substrate, pixel electrodes, position detection electrodes, switching components, position detection lines, and an insulating film. The pixel electrodes are disposed on the substrate. The position detection electrodes are disposed on the substrate and configured to detect positions of input by a position input member. The switching components are disposed in a layer lower than layers in which the pixel electrodes and the position detection electrodes are disposed on the substrate and connected to the pixel electrodes, respectively. The position detection lines are disposed in a layer lower than the layer in which the switching components are disposed and electrically connected to the position detection electrodes. The insulating film is disposed between the position detection lines and the switching components.

### CROSS REFERENCE TO RELATED APPLICATION

This application claims priority from Japanese Patent Application No. 2017-193310 filed on Oct. 3, 2017. The entire contents of the priority application are incorporated herein by reference.

### TECHNICAL FIELD

The technology described herein relates to a display device.

### BACKGROUND

A display device having touch panel function produced with the in-cell technology has been known. The display device includes a substrate, position detection electrodes (touch electrodes), pixel electrodes, and a driver (a source driving touch sensing IC) that are provided on the substrate. The position detection electrodes are electrically connected to the driver via position detection lines (touch routing lines). An example of such a display device is disclosed in Japanese Patent Application Publication No. 2016-38594.

In recent years, improvement in definition (resolution) of display panels is expected. To improve the definition of a display panel, the display panel requires a larger number of lines on a substrate with higher density. In layout design of position detection lines, the position detection lines need to be routed not to contact other lines, that is, flexibility in the designing decreases.

### SUMMARY

The technology described herein was made in view of the above circumstances. An object is to provide a display panel including position detection lines that are less likely to contact other lines.

A display panel includes a substrate, pixel electrodes, position detection electrodes, switching components, position detection lines, and an insulating film. The pixel electrodes are disposed on the substrate. The position detection electrodes are disposed on the substrate and configured to detect positions of input by a position input member. The switching components are disposed in a layer lower than layers in which the pixel electrodes and the position detection electrodes are disposed on the substrate and connected to the pixel electrodes, respectively. The position detection lines are disposed in a layer lower than the layer in which the switching components are disposed and electrically connected to the position detection electrodes. The insulating film is disposed between the position detection lines and the switching components. Because the position detection lines are disposed in the layer lower than the layer in which the switching components are disposed, the position detection lines are less likely to contact the lines connected to the switching components. Therefore, flexibility in layout design of the lines improves.

According to the technology described herein, the position detection lines are less likely to contact other lines.

### BRIEF DESCRIPTION OF THE DRAWINGS

FIG. 1 is a cross-sectional view of a liquid crystal display device according to a first embodiment along the longitudinal direction (the Y-axis direction) of the liquid crystal display device.

FIG. 2 is a plan view illustrating a display area of an array substrate.

FIG. 3 is a cross-sectional view along line in FIG. 2 illustrating the array substrate.

FIG. 4 is a plan view schematically illustrating the array substrate.

FIG. 5 is a cross-sectional view along line V-V in FIG. 2 illustrating a connecting point between a source line and a position detection line.

FIG. 6 is a cross-sectional view illustrating a forming process of a contact hole that is for connecting the source line to the position detection line.

FIG. 7 is a plan view illustrating a display area of an array substrate according to a second embodiment.

FIG. 8 is a cross-sectional view alone line VIII-VIII in FIG. 7 illustrating a connecting point between a source line and a position detection line.

### DETAILED DESCRIPTION

### First Embodiment

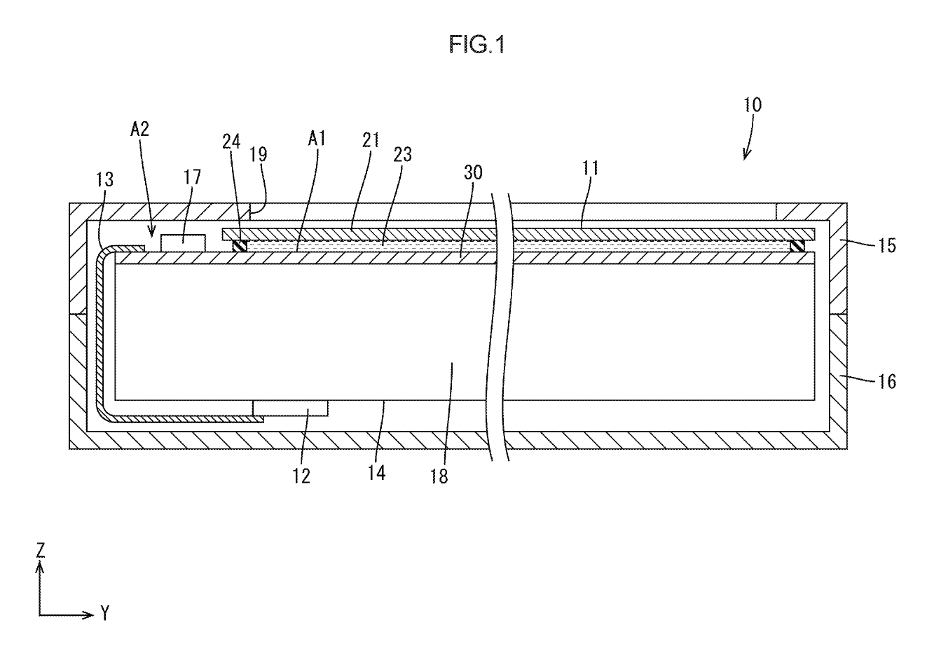

A first embodiment will be described with reference to FIGS. 1 to 6. As illustrated in FIG. 1, a liquid crystal display device 10 includes a liquid crystal panel 11 (a display panel), a control circuit board 12 (an external signal source), and a flexible circuit board 13 (an external component connecting member), and a backlight unit 14 (a lighting device). The liquid crystal panel 11 includes a driver 17. The control circuit board 12 is configured to supply various input signals to the driver 17. The flexible circuit board 13 electrically connects the liquid crystal panel 11 to the control circuit board 12. The backlight unit 14 is an external light source configured to supply light to the liquid crystal panel 11. As illustrated in FIG. 1, the backlight unit 14 includes a chassis 18, a light source, and an optical member. The chassis 18 has a box shape with an opening on the front side (closer to the liquid crystal panel 11). The light source is disposed inside the chassis 18. The light source may include cold cathode fluorescent tubes, LEDs, or organic light-emitting diodes. The optical member is disposed to cover the opening of the chassis 18. The optical member has a function for converting light emitted by the light source into planar light. The liquid crystal panel 11 includes a display area A1 for display images and a non-display area A2 that surrounds the display area A1.

As illustrated in FIG. 1, the liquid crystal display device 10 further includes a front exterior component 15 and a rear exterior component 16. The liquid crystal panel 11 and the backlight unit 14 are attached to each other and held in a space defined by the front exterior component 15 and the rear exterior component 16. The front exterior component 15 includes an opening 19 through which images displayed in the display area A1 are viewed. An application of the liquid crystal display device 10 includes various electronic devices such as portable phones (including smartphones), notebook personal computers (including tablet personal computers), wearable terminals (including smartwatches), portable information terminals (including electronic book players and PDAs), portable video game players, and digital photo frames.

As illustrated in FIG. 1, the liquid crystal panel 11 includes substrates 21 and 30, a liquid crystal layer 23 (a medium layer), and a sealant 24. The substrates 21 and 30 are opposed to each other. The liquid crystal layer 23 includes liquid crystal molecules that are substances having optical characteristics that alter according to application of an electric field. The sealant 24 is disposed between the substrates 21 and 30 to surround the liquid crystal layer 23 and to seal the liquid crystal molecules in a space defined by the substrates 21 and 30 and the sealant 24. One of the substrates 21 and 30 on the front side (the upper side in FIG. 1) is a CF substrate 21 (a common substrate). The other one of the substrates 21 and 30 on the rear side (the back side) is an array substrate 30 (an active matrix substrate, a component-side substrate). The liquid crystal molecules included in the liquid crystal layer 23 are horizontally oriented. The orientation of the liquid crystal molecules is not limited to the horizontal orientation. Polarizing plates are attached to outer surfaces of the substrates 21 and 30. The CF substrate 21 includes a glass substrate, a color filter, an overcoat film, and an alignment film. The color filter, the overcoat film, and the alignment film are disposed on top of each other on the inner surface of the substrate (on the liquid crystal layer 23 side). The color filter includes red (R), green (G), and blue (B) segments arranged in a matrix. The color segments are opposed to pixels on the array substrate 30.

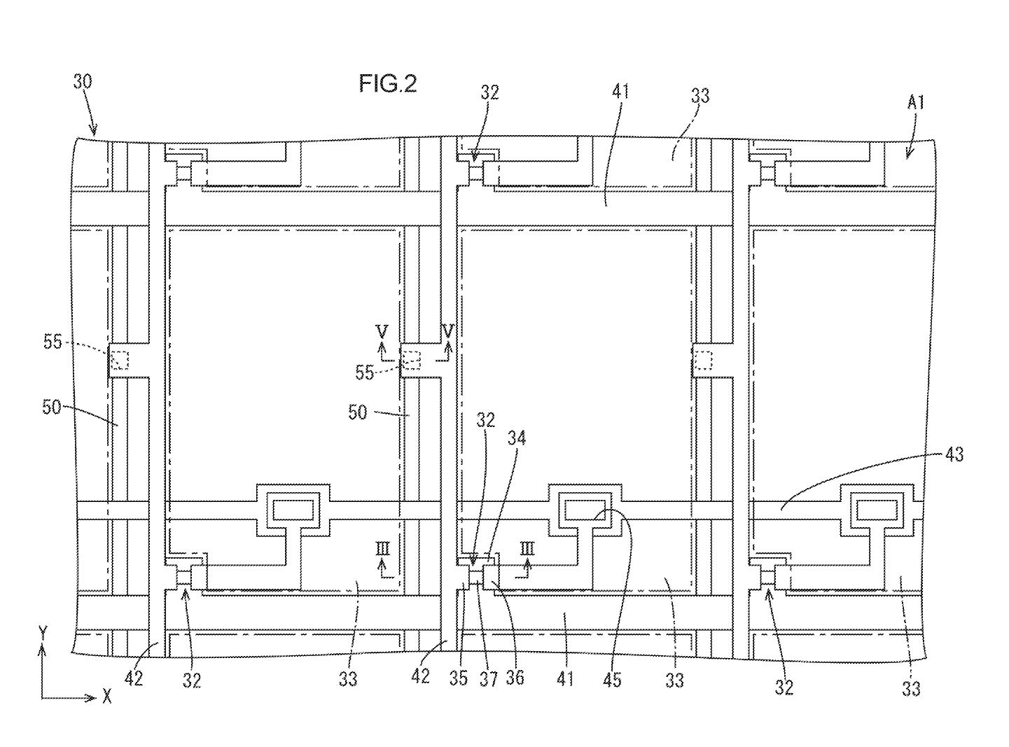

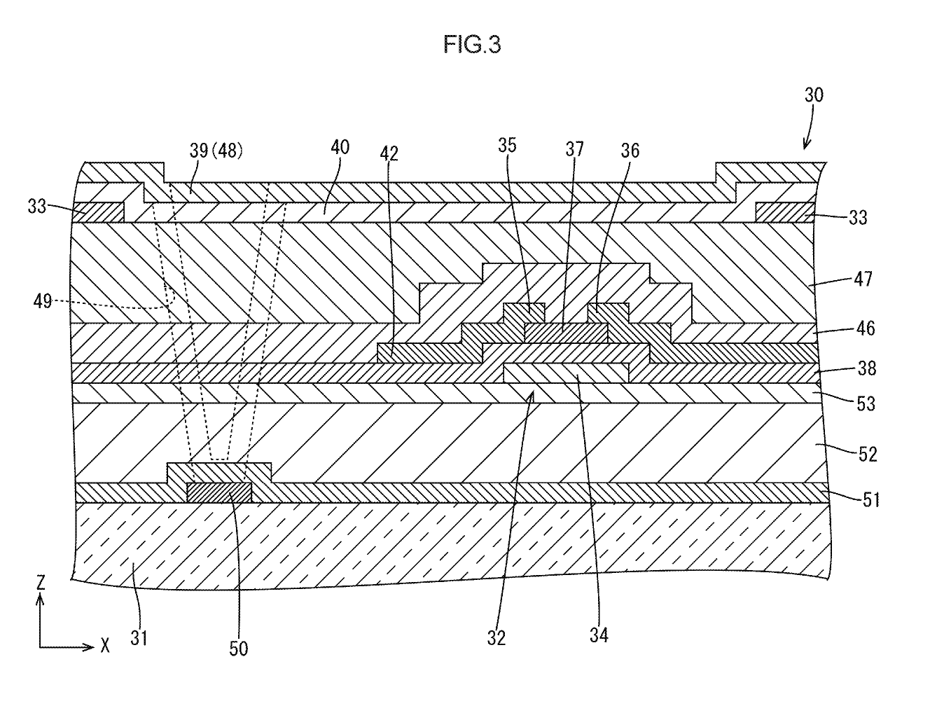

As illustrated in FIGS. 2 and 3, the array substrate 30 includes a glass substrate 31 and multiple layers formed on top of each other on the inner surface of the glass substrate 31 using a photolithography method. The driver 17 (a panel driver) for driving the liquid crystal panel 11 is disposed in an area of the glass substrate 31 closer to one of edges of the glass substrate 31 (a section of the non-display area A2). In the display area A1, thin film transistors (TFTs) 32 (display components) and pixel electrodes 33 are disposed in a matrix on the inner surface of the glass substrate 31 (on the liquid crystal layer 23 side, the upper side in FIG. 3). The TFTs 32 are switching components. The TFTs 32 are disposed in a layer lower than layers in which the pixel electrodes 33 and the position detection electrodes 48 are disposed and connected to the pixel electrodes 33, respectively. The TFTs include gate electrodes 34, source electrodes 35, drain electrodes 36, and channels 37. Each channel 37 is disposed to overlap the corresponding gate electrode 34 and insulated from the gate electrode 34 with a gate insulating film 38 disposed between the channel 37 and the gate electrode 34. Each channel 37 connects the corresponding source electrode 35 to the corresponding drain electrode 36. An interlayer insulating film 46 is disposed in a layer upper than the channels 37, the source electrodes 35, and the drain electrodes 36. A planarization film 47 is disposed on the interlayer insulating film 46. The pixel electrodes 33 are formed on the planarization film 47. The drain electrodes 36 are electrically connected to the pixel electrodes 33 via contact holes 45 illustrated in FIG. 2.

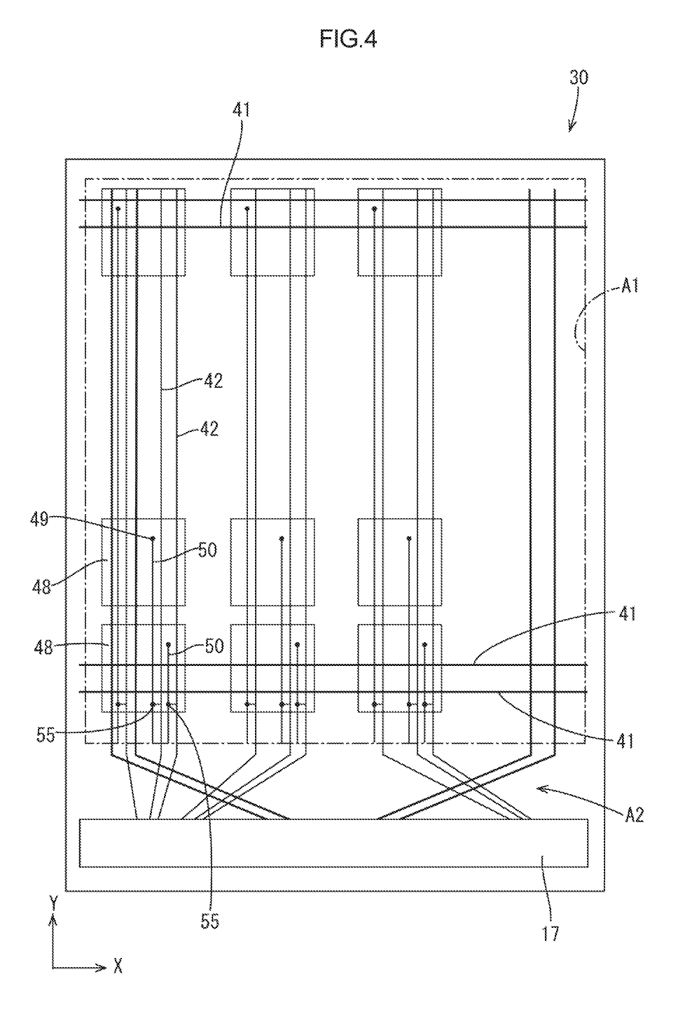

The gate electrodes 34, the source electrodes 35, and the drain electrodes 36 are constructed from, but not limited to, laminated films, each of which includes a titanium (Ti) layer and a copper (Cu) layer. As illustrated in FIG. 2, gate lines 41 and source lines 42 are routed to form a grid to surround the TFTs 32 and the pixel electrodes 33. The gate electrodes 34 are connected to the gate lines 41. The source electrodes 35 are connected to the source lines 42. As illustrated in FIG. 4, ends of the source lines 42 closer to the driver 17 are connected to the driver 17. With the source lines 42, the source electrodes 35 are electrically connected to the driver 17. Ends of the gate lines 41 are connected to the driver 17. With the gate lines 41, the gate electrodes 34 are electrically connected to the driver 17.

The TFTs 32 are driven based on signals supplied by the driver 17 via the gate lines 41 and the source lines 42. Application of voltages to the pixel electrodes 33 is controlled according to the driving of the TFTs 32. The array substrate 30 includes capacitance lines 43 (Cs lines) which extend in the X-axis direction. The capacitance lines 43 are made of the same material as that of the gate lines 41. The capacitance lines 43 and the gate lines 41 are formed in the same layer in the same step. The capacitance lines 43 and the pixel electrodes 33 form capacitors to hold potentials charged at the pixel electrodes 33 for a predefined period.

As illustrated in FIG. 3, a common electrode 39 is formed in a layer more to the front than the pixel electrodes 33. The common electrode 39 is insulated from the pixel electrodes 33 with an interlayer insulating film 40 disposed between the pixel electrodes 33 and the common electrode 39. Each of the gate insulating film 38 and the interlayer insulating films 40 and 46 is constructed from, but not limited to, a laminated film including a silicon dioxide (SiO2) layer and a silicon nitride (SiNx) layer. The common electrode 39 includes slits. When each pixel electrode 33 is charged, a potential difference is created between the pixel electrode 33 and the common electrode 39. A fringe electric field (an oblique electric field) is generated between an opening edge of the slit of the common electrode 39 and the pixel electrode 33 including a component along the plate surface of the array substrate 30 and a component in a normal direction to the plate surface of the array substrate 30. Using the fringe electric field, the orientation of the liquid crystal molecules in the liquid crystal layer 23 can be controlled. Namely, the liquid crystal panel 11 operates in fringe field switching (FFS) mode.

The liquid crystal display device 10 is an in-cell type liquid crystal display device having a display function for displaying images and a touch panel function (a position detection function) for detecting positions of input by a user performed according to the images displayed in the display area A1. The touch panel uses a projected-capacitive touch panel technology, for instance, a self-capacitive technology. As illustrated in FIG. 4, the position detection electrodes 48 (the touch electrodes) are disposed in a matrix within the plate surface of the array substrate 30. The common electrode 39 includes the position detection electrodes 48.

The position detection electrodes 48 are disposed in an area of the glass substrate 31 in the display area A1. When the user of the liquid crystal display device 10 brings his or her fingertip (a position input member) to the surface (the display surface) of the liquid crystal panel 11, a capacitor is formed between the fingertip and the position detection electrode 48 because fingertip is a conductor. A capacitance of the capacitor between the fingertip and the position detection electrode 48 adjacent to the fingertip and measured at the position detection electrode 48 is different from capacitances measured at position detection electrodes 48 farther from the fingertip. According to the difference, the position of input by the fingertip can be detected. The position detection electrodes 48 are connected to position detection lines 50 via contact holes 49 (see FIG. 3). In FIG. 3, the position detection electrodes 48 are directly connected with the position detection lines 50. However, the position detection electrodes 48 may be connected to the position detection lines 50 via a conductive film for forming source electrodes or drain electrodes (a source metal or a drain metal) or a conductive film for forming a gate electrodes (a gate metal).

As illustrated in FIG. 4, the position detection lines 50 extend from the position detection electrodes 48 toward the driver 17. The position detection lines 50 are electrically connected to the driver 17 via the source lines 42. To detect positions of input using the position detection electrodes 48, the control circuit board 12 supplies drive signals to the position detection electrodes 48 via the driver 17, the source lines 42, and the position detection lines 50 and receives detection signals from the position detection electrodes 48 via the driver 17, the source lines 42, and the position detection lines 50. Namely, the driver 17 is configured to supply the drive signals to the position detection electrodes 48 to control the position detection electrodes 48. The driver 17 is electrically connected to the pixel electrodes 33 via the gate lines 41 and the source lines 42. To display images, the driver 17 supplies drive signals to the pixel electrodes 33 to control the pixel electrodes 33. The source lines 42 extend such that the ends of the source lines 42 closer to the driver 17 bend toward each other in a plan view as illustrated in FIG. 4. The gate lines 41 include lead lines. The gate lines 41 are electrically connected to the driver 17 via the lead lines.

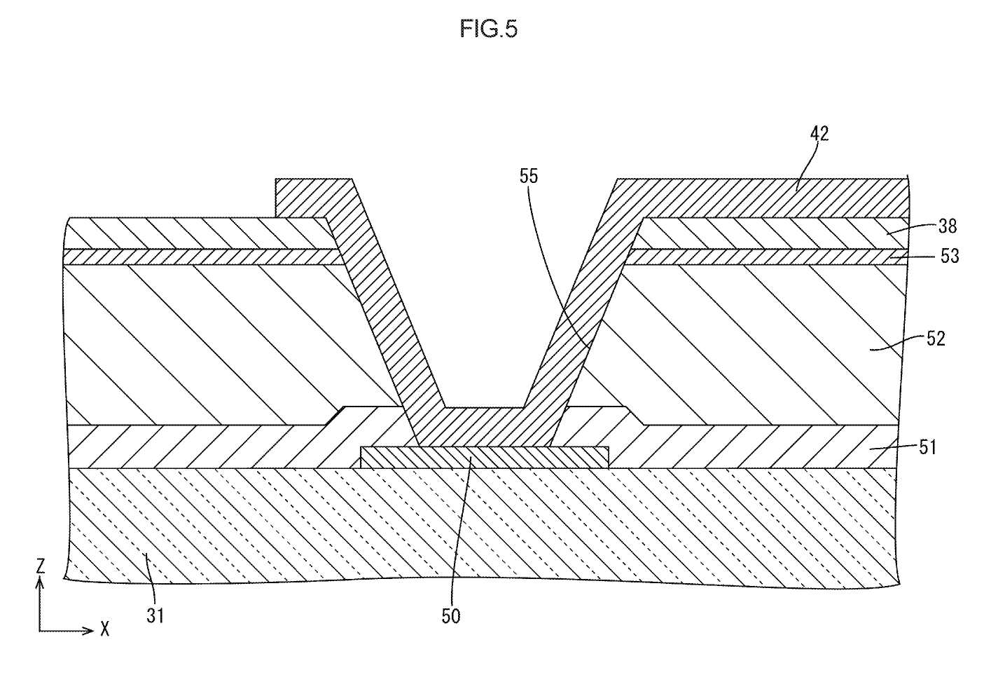

As illustrated in FIG. 2, the position detection lines 50 extend along the source lines 42 in the plan view. As illustrated in FIG. 3, the position detection lines 50 are formed on the surface of the glass substrate 31. The position detection lines 50 are disposed in the layer lower than the TFTs 32, more specifically, lower than the gate electrodes 34, namely, the closest to the glass substrate 31 (the lowest layer). A CAP film 51, a SOG film 52, and a CAP film 53, which are insulating films, are disposed between the position detection lines 50 and the TFTs 32. As illustrated in FIG. 5, the position detection lines 50 are electrically connected to the source lines 42 via contact holes 55 in the gate insulating film 38, the CAP film 51, the SOG film 52, and the CAP film 53.

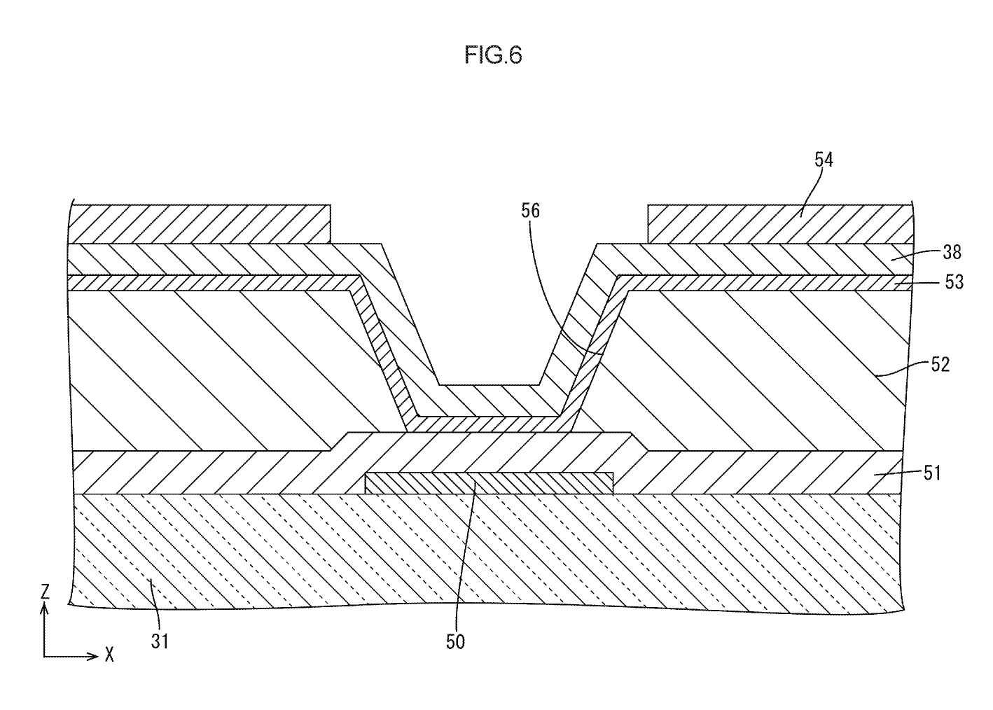

The contact holes 55 are formed as follows. As illustrated in FIG. 6, recesses 56 are formed in the SOG film 52 in a SOG film 52 forming step, the CAP film 53 and the gate insulating film 38 are formed, and then the CAP films 51 and 53 and the gate insulating film 38 are etched (e.g., through dry etching) using a resist 54 to remove sections of the CAP films 51 and 53 and the gate insulating film 38 at the same time. Through the steps, the contact holes 55 are formed. The SOG film 52 is a silicon oxide film formed by applying a glassy solution mixed with an organic solution to a top surface of the CAP film 51 through spin coating and heating. The CAP films 51 and 53 are made of the same material as that of the gate insulating film 38 or the interlayer insulating films 40 and 46 (e.g., SiO2 and SiNx). In the CAP films 51 and 53 made of the same material as that of the gate insulating film 38, the contact holes 55 are formed by etching sections of the CAP films 51 and 53 and sections of the gate insulating film 38 are easily removed in one step.

Effects will be described. In this embodiment, the position detection lines 50 are disposed in the layer lower than the TFTs 32. Therefore, the position detection lines 50 are less likely to contact other lines for connecting the position detection lines 50 to the TFTs 32 (e.g., the gate lines 41 and the source lines 42). Flexibility in layout design of the lines increases. Specifically, the position detection lines 50 are disposed in the layer different from the layers in which the gate lines 41 and the source lines 42 are disposed. Therefore, the position detection lines 50 can be routed regardless of the layout of the gate lines 41 or the layout of the source lines 42. Furthermore, the CAP film 51, the SOG film 52, and the CAP film 53 are disposed between the position detection lines 50 and the source lines 42 or the gate lines 41. The position detection lines 50 are separated from the source lines 42 or the gate lines 41 in the thickness direction of the array substrate 30 (the Z-axis direction) and thus parasitic capacitances can be reduced.

This embodiment includes the driver 17 and the source lines 42. The driver 17 is disposed on the glass substrate 31 and configured to control the pixel electrodes 33 and the position detection electrodes 48. The source lines 42 connect the source electrodes 35 of the TFTs 32 to the driver 17. The position detection lines 50 are electrically connected to the source lines 42 via the contact holes 55 in the SOG film 52. The position detection lines 50 are connected to the driver 17 using the sections of the source lines 42. According to the configuration, lead lines for connecting the position detection lines 50 to the driver 17 are not required. In this embodiment, the driver 17 for controlling the pixel electrodes 33 and the position detection electrodes 48 is disposed in the area of the array substrate 30 close to one of the edges of the array substrate 30. The lines extend such that ends of the lines closer to the driver 17 bend toward each other. According to the configuration, forming of the lead lines for connecting the position detection lines 50 to the driver 17 is difficult. Because the lead lines for connecting the position detection lines 50 to the driver 17 are not required, this embodiment does not have such a problem.

The SOG film 52 is provided as an insulating film. Because the SOG film 52 can be easily planarized, the SOG film 52 is preferable for an underlayer under the TFTs 32. The position detection lines 50 are directly formed on the surface of the glass substrate 31. According to the configuration, the position detection lines 50 can be easily planarized.

### Second Embodiment

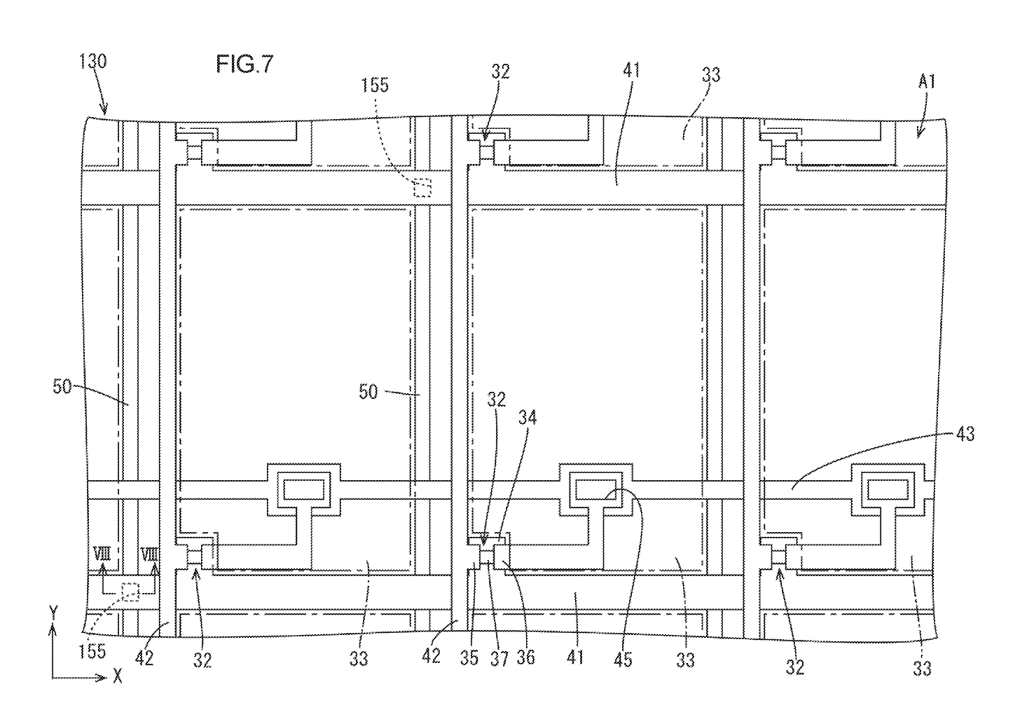

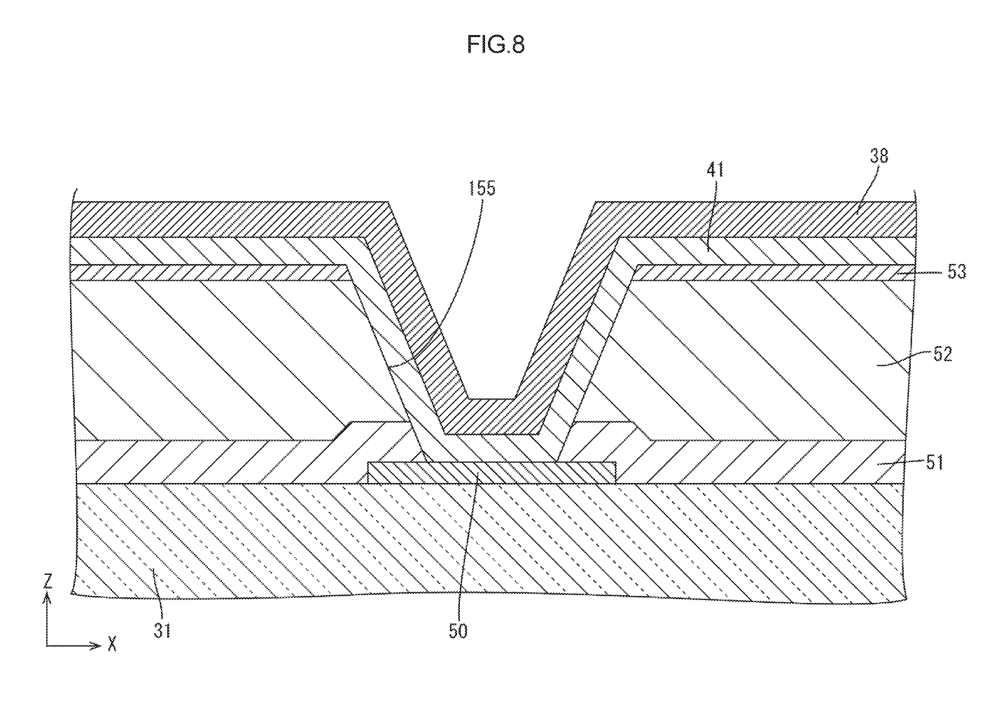

A second embodiment will be described with reference to FIGS. 7 and 8. Components and portions the same as those of the first embodiment will be indicated with the same reference symbols and will not be described. As illustrated in FIGS. 7 and 8, this embodiment includes an array substrate 130. The array substrate 130 includes the position detection lines 50, the CAP film 51, the SOG film 52, the CAP film 53, and the gate lines 41. The CAP film 51, the SOG film 52, and the CAP film 53 include contact holes 155. The position detection lines 50 are electrically connected to the gate lines 41 via the contact holes 155. According to the configuration, the position detection lines 50 are connected to the driver 17 using sections of the gate lines 41. Therefore, lead lines for connecting the position detection lines 50 to the driver 17 are not required.

### Other Embodiments

The technology described herein is not limited to the embodiments described above and with reference to the drawings. The following embodiments may be included in the technical scope.

(1) The common electrode 39 may be provided separately from the position detection electrodes 48.

(2) The position detection lines 50 may be directly connected with the driver 17.

(3) Different types of insulating films may be disposed between the position detection lines 50 and the TFTs 32.

(4) The position detection lines 50 may be disposed in any layer between the glass substrate 31 and the TFTs 32.

(5) Conductive films and insulating films made of materials other than those in the above embodiments may be formed on the glass substrate 31.

(6) The position detection lines 50 may be connected to the source lines 42 or the gate lines 41 at points in the non-display area A2. Namely, the contact holes 55 or 155 may be located in the non-display area A2.

1. A display panel comprising:
a substrate;
a plurality of pixel electrodes disposed on the substrate;
a plurality of position detection electrodes disposed on the substrate and configured to detect positions of input by a position input member;
a plurality of switching components disposed in a layer lower than layers in which the pixel electrodes and the position detection electrodes are disposed on the substrate and connected to the pixel electrodes, respectively;
position detection lines disposed in a layer lower than the layer in which the switching components are disposed and electrically connected to the position detection electrodes; and
an insulating film disposed between the position detection lines and the switching components.

2. The display panel according to claim 1, further comprising:
a driver disposed on the substrate and configured to control the pixel electrodes and the position detection electrodes; and
source lines connecting source electrodes of the switching components to the driver, wherein
the position detection lines are electrically connected to the source lines via contact holes in the insulating film.

3. The display panel according to claim 1, further comprising:
a driver disposed on the substrate and configured to control the pixel electrodes and the position detection electrodes; and
gate lines connecting gate electrodes of the switching components to the driver, wherein
the position detection lines are electrically connected to the gate lines via contact holes in the insulating film.

4. The display panel according to claim 1, wherein the insulating film includes a SOG film.

5. The display panel according to claim 1, wherein the position detection lines are disposed on a surface of the substrate.
